(19) United States
(12) Patent Application Publication
(10) Pub. No.: US 2025/0289378 A1
(43) Pub. Date: Sep. 18, 2025

(54) COUPLING STRUCTURE AND VEHICLE

(71) Applicant: Isuzu Motors Limited, Yokohama-shi (JP)

(72) Inventors: Yasuo MIYAHARA, Fujisawa-shi (JP); Yusuke OBOKATA, Fujisawa-shi (JP); Daisuke MIZUTAMARI, Fujisawa-shi (JP); Keisuke MATSUI, Fujisawa-shi (JP); Hiroki OTA, Fujisawa-shi (JP)

(73) Assignee: Isuzu Motors Limited, Yokohama-shi (JP)

(21) Appl. No.: 19/041,360

(22) Filed: Jan. 30, 2025

(30) Foreign Application Priority Data
Mar. 14, 2024 (JP) 2024-040385

(51) Int. Cl. B60R 16/02; H01R 13/533; H01R 13/58

(52) U.S. Cl. CPC B60R 16/0215; H01R 13/533; H01R 13/582; B60Y 2200/412

(57) ABSTRACT

A coupling structure includes: a retainer including a first holding member and a second holding member, the first holding member including a plurality of grooves in which a plurality of harnesses are disposed, and the second holding member being disposed to be opposed to the first holding member and closing the grooves; a connector coupled to the harnesses; and an outer cover provided around outer peripheries of the retainer and the connector.

### CROSS REFERENCE TO RELATED APPLICATIONS

This application is based upon and claims the benefit of priority from prior Japanese Patent Application No. 2024-040385, filed Mar. 14, 2024, the entire contents of which are incorporated herein by reference.

### FIELD

The present invention relates generally to a coupling structure and a vehicle.

### BACKGROUND

In an engine of a vehicle, a coupling structure is used in which a plurality of harnesses are coupled to a connector and a connector cover is mounted as disclosed in Jpn. Pat. Appln. KOKAI Publication No. H1-105482.

For example, a plurality of terminals formed at distal ends of a plurality of wire harnesses are inserted in a plurality of terminal holes provided in a connector, and a connector cover surrounding an outer periphery of an insertion portion is mounted.

In such a coupling structure, for example, if the harnesses move due to vibration of the engine, there is a case where the harnesses are damaged due to bending or interference with the outside. Thus, a coupling structure with high retainability and a high damping property is required.

### SUMMARY

According to an aspect of the present invention, a coupling structure comprises: a retainer including a first holding member and a second holding member, the first holding member including a plurality of grooves in which a plurality of harnesses are disposed, and the second holding member being disposed to be opposed to the first holding member and closing the grooves; a connector coupled to the harnesses; and an outer cover provided around outer peripheries of the retainer and the connector.

### BRIEF DESCRIPTION OF THE DRAWINGS

FIG. 1 is a perspective view illustrating a configuration of a coupling structure according to an embodiment of the present invention.

FIG. 2 is an exploded perspective view of the coupling structure according to the embodiment.

FIG. 3 is an explanatory view illustrating an assembling procedure of the coupling structure according to the embodiment.

FIG. 4 is an explanatory view illustrating an assembling procedure of the coupling structure according to the embodiment.

FIG. 5 is a perspective view illustrating a coupling structure according to another embodiment.

FIG. 6 is an explanatory view of a vehicle according to an embodiment of the present invention.

### DETAILED DESCRIPTION

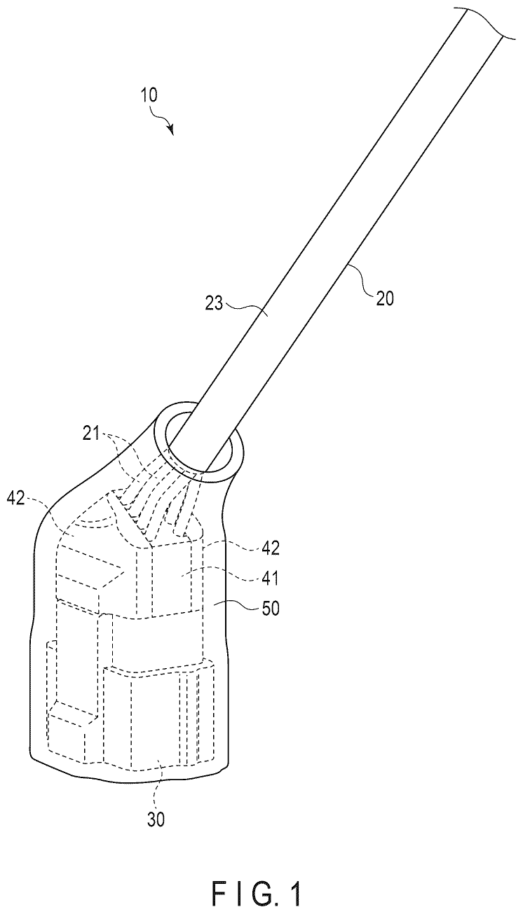

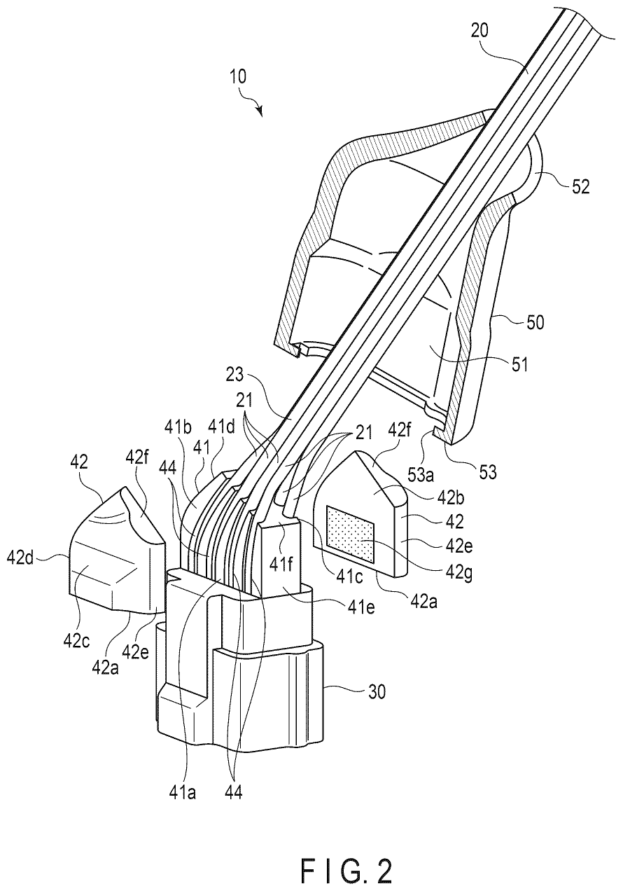

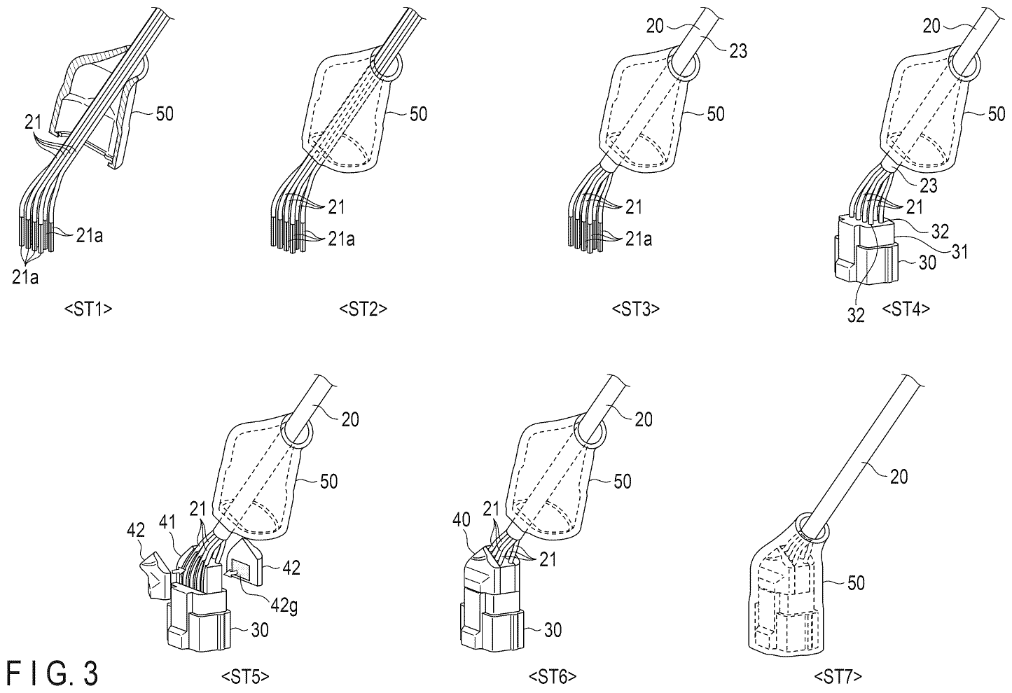

Hereinafter, a coupling structure according to an embodiment is described with reference to FIG. 1 to FIG. 3. FIG. 1 and FIG. 2 are a perspective view and an exploded perspective view of the coupling structure according to the embodiment. FIG. 2 illustrates a cross-sectional shape of an outer cover 50 by cutting out a part thereof, for the purpose of description. FIG. 3 is an explanatory view illustrating an assembling procedure. In the Figures, X, Y and Z indicate three mutually orthogonal directions. Note that in each Figure, for the purpose of description, structures are illustrated by being enlarged, reduced or omitted as appropriate.

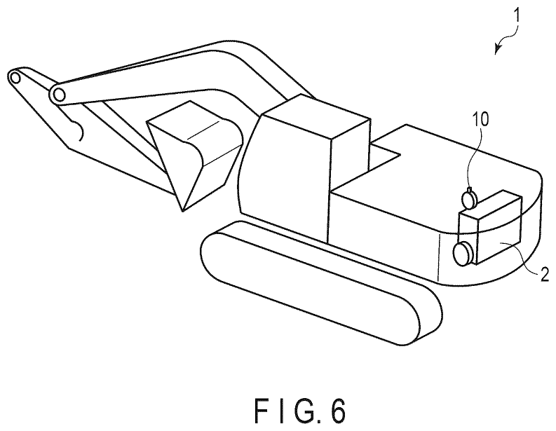

As illustrated in FIG. 1 and FIG. 2, a coupling unit 10 (coupling structure) includes a cable 20, a connector 30 in which a distal portion of the cable 20 is inserted, a retainer 40, and an outer cover 50. For example, the coupling unit 10 is a coupling unit that couples an engine harness provided in an engine of a vehicle. In one example, the coupling unit 10 is used for wiring coupling of a turbo charger provided in an engine 2 of a vehicle 1 such as a power shovel, for example, as illustrated in FIG. 6.

The electric cable 20 (electric line) is configured such that a plurality of harnesses 21 (wiring lines) are bundled by an exterior member 23. For example, the electric cable 20 includes a covered part in which the harnesses 21 are gathered and covered by the exterior member 23, and an exposed part in which distal portions of the harnesses 21 are exposed from the exterior member 23. In the present embodiment, by way of example, such a configuration is illustrated that the electric cable 20 includes eight harnesses 21, and the eight harnesses 21 are coupled to the connector 30 by being arranged in two rows each including four harnesses 21.

The harness 21 is configured such that a copper wire is sheathed therein. A terminal 21a is provided on a distal portion of the harness 21. The terminals 21a of the harnesses 21 are inserted in terminal holes 32 of the connector 30, and electrically coupled to contact portions provided in the terminal holes 32.

For example, the exterior member 23 is a tape-like or a tube-like member that is formed of a resin such as vinyl chloride, and is wound around the harnesses 21.

The connector 30 includes a connector housing 31 in which the terminal holes 32, in which the terminals 21a of the harnesses 21 are inserted, are formed. In the connector housing 31, contact portions that are coupling targets, for example, are provided. In one example, the terminals holes 32 are arranged in two rows in an upper surface portion of the connector housing 31.

The retainer 40 includes a first holding member 41, and one second holding member 42 disposed to be opposed to a surface of the first holding member 41 or a plurality of second holding members 42 disposed to be opposed to surfaces of the first holding member 41.

In the present embodiment, the retainer 40 is composed of one first holding member 41 and a pair of second holding members 42.

The first holding member 41 is formed of, for example, a rubber material such as silicone rubber, or a resin material, in a block shape or a plate shape. For example, the first holding member 41 includes a bottom surface portion 41a that is opposed to an upper end surface of the connector housing 31 of the connector 30, a pair of holding surface portions 41b and 41c (surface portions) in which a plurality of grooves 44 are formed, a pair of side surface portions 41d and 41e, and an upper surface portion 41f.

The grooves 44, in which the harnesses 21 are disposed, are formed in the paired holding surface portions 41b and 41c. An inner surface of the groove 44 includes a curved surface portion having an R along an outer surface of the harness 21. For example, the inner surface of the groove 44 includes a curved surface portion having an arcuate cross-sectional shape.

The second holding member 42 is formed of, for example, a rubber material such as silicone rubber, or a resin material, in a block shape or a plate shape. For example, the second holding member 42 includes a bottom surface portion 42a that is opposed to the upper end surface of the connector housing 31 of the connector 30, a holding surface portion 42b (surface portion) that is disposed to be opposed to the holding surface portion 41b, 41c of the first holding member 41, an outer wall portion 42c that is disposed to be opposed to the outer cover, a pair of side surface portions 42d and 42e, and an upper surface portion 42f. For example, as a bonding member, a double-sided adhesive tape 42g is attached to the holding surface portion 42b.

In a state in which the harnesses 21 are disposed in the grooves 44 of the holding surface portions 41b and 41c of the first holding member 41, the paired second holding members 42 are disposed to be opposed to the holding surface portions 41b and 42c, and are adhered to the first holding member 41 by, for example, the adhesive tape 42g, thereby closing the grooves 44. The retainer 40, in which the first holding member 41 and the paired second holding members 42 are assembled, has an outer surface along an inner surface shape of the outer cover 50.

The outer cover 50 is a case member that is formed of a rubber material or a resin material, and that forms therein an accommodation chamber 51 that accommodates the connector 30 and the retainer 40. For example, the outer cover 50 is formed in a cylindrical shape with one end and the other end being opened. The outer cover 50 includes, on one end side, a lead-out port 52 that is formed along an outside diameter of the cable 20, and includes, on the other end side, a flange port 53 that is engaged with a lower side of the connector 30. For example, the flange port 53 of the outer cover 50 includes a protruding edge portion 53a that inwardly protrudes, and an inner edge of the protruding edge portion 53a is formed slightly narrower than an outer peripheral wall of the connector 30. Accordingly, at a time of assembly, the retainer 40 and connector 30 are accommodated in the accommodation chamber 51 of the outer cover 50, and the protruding edge portion 53a of the flange port 53 is engaged with, and held by, the lower surface side of the connector 30.

Assembly steps of the coupling unit 10 having the above-described configuration is described with reference to FIG. 3.

To start with, in ST1, terminals 21a are press-bonded to distal portions of the harnesses 21 that constitute the electric cable 20. Subsequently, in ST2, the electric cable 20 is inserted into the outer cover 50. For example, the electric cable 20 is inserted, from the distal side, into the lead-out port 52 of the outer cover 50. Then, in ST3, the exterior member 23 is attached on those parts of the harnesses 21, which exclude the distal portions of the harnesses 21. For example, the harnesses 21 are bundled by, for example, winding a tape-like exterior member around the harnesses 21. Then, in ST4, the terminals 21a are inserted in, and electrically coupled to, the terminal holes 32 of the connector 30. Further, in ST5, the retainer 40 is attached. Specifically, the first holding member 41 is disposed between the harnesses 21 that are arranged in two rows, and the harnesses 21 are disposed in the corresponding holding grooves 44 one by one. The second holding members 42 are disposed to be opposed to each other, and the first holding member 41 and the second holding members 42 are attached and bonded by the adhesive tapes 42g, and thereby the retainer 40 is assembled as illustrated in ST6. Subsequently, in ST7, the outer cover 50, through which the electric cable 20 is previously passed, is put on, and engaged with, the connector 30 and retainer 40. At this time, while the flange port 53 of the outer cover 50 is being stretched out, the protruding edge portion 53a of the flange 53 is moved to the lower side of the connector 30, and engaged with and held by the lower end portion of the connector 30.

By the above, the connector 30 and retainer 40 are disposed in the accommodation chamber 51, and the harnesses 21 are held in the grooves 44.

According to the coupling unit 10 of the present embodiment, the harnesses 21 are held in the grooves 44 formed in the opposed surfaces of the members 41 and 42 that are disposed to be opposed to each other, and are covered by the outer cover 50. By this configuration, since the harnesses 21 can be individually held in the grooves 44 within the outer cover 50, non-uniformity in wiring can be suppressed, and the retainability and damping property can be improved. For example, by using the retainer 40, the strain of the harnesses 21 that receive vibration can be reduced to, for example, about ⅕. Thus, breakage of the harnesses 21 due to vibration can be prevented. In addition, according to the coupling unit 10, simply by disposing the members 41 and 42 such that the members 41 and 42 are opposed to each other, and covering the members 41 and 42 with the outer cover 50, the harnesses 21 can easily be retained and protected. For example, in a case where a filler such as a silicone material is injected in the space in the outer cover after the outer cover is attached, a hole for injection becomes necessary and time is needed for curing the filler. Moreover, in the method of injecting the filler into the outer cover, there may occur such problems as leakage of the filler, mixing of bubbles, and deficient filling. By contrast, according to the above-described embodiment, a coupling structure with high reliability can easily be obtained by simply assembling the holding members 41 and 42 having shapes along the shape of the accommodation chamber 51 of the outer cover 50.

The present invention is not limited to the above-described embodiment. For example, the arrangement of the harnesses 21, and the specific shapes and arrangement of the members 41 and 42 of the retainer 40 are not limited to those described above, and appropriate changes can be made in practice.

For example, in the above embodiment, the example in which the retainer 40 is composed of three members 41 and 42 was described, but the embodiment is not limited to this. The retainer 40 may be composed of two members, or four or more members.

In addition, in the above embodiment, the example was described in which the grooves 44 are formed on the first holding member 41 side, but the embodiment is not limited to this. For example, the grooves 44 may be formed in the holding surface portion 42b that is the opposed surface of the second holding member 42, or the grooves 44 may be formed in both the holding surface portions 41b and 41c and the holding surface portion 42b, which are the opposed surfaces of the first holding member 41 and the second holding member 42.

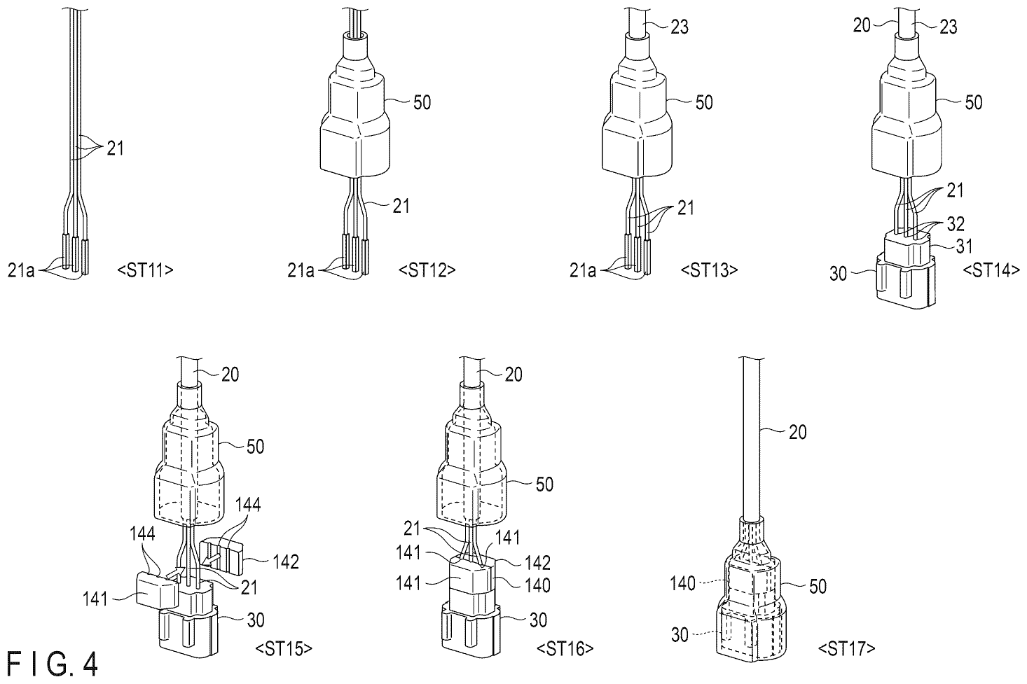

For example, in an example that is illustrated in FIG. 4 as another embodiment, a retainer 140 includes one first holding member 141 and one second holding member 142. In this embodiment, grooves 144 are formed in both opposed surfaces of the first holding member 141 and second holding member 142 of the retainer 140. The other structure of the retainer 140 is similar to the structure of the retainer 40 of the above-described first embodiment. Besides, the structures of the electric cable 20, connector 30 and outer cover 50 are similar to those in the above-described first embodiment.

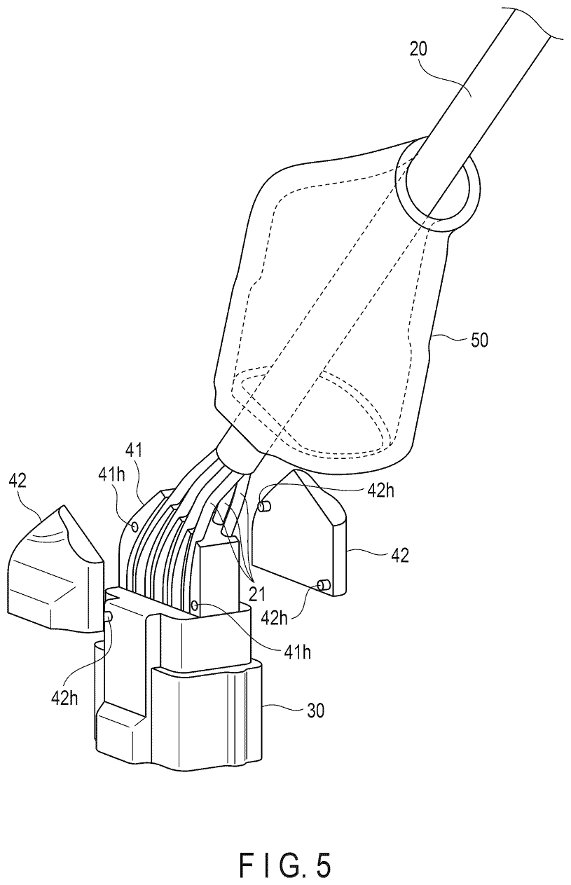

Additionally, in the above-described embodiment, the example was described in which the first holding member 41 and the second holding members 42 are bonded by the adhesive tapes 42g, but the embodiment is not limited to this. For example, as illustrated in FIG. 5 as another embodiment, projection portions 42h may be formed on one of the holding surface portions 41b and 42b of the members 41 and 42, and recess portions 41h may be formed on the other of the holding surface portions 41b and 42b. By fitting the projection portions 42h in the recess portions 41h, the members 41 and 42 may be positioned.

The embodiments of the present invention have been described above in detail. The present invention is not limited to the above embodiments, and modifications, improvements and the like may be made as appropriate. The present invention includes all changes that are indicated 10 by the claims and that are within the meanings and scopes of the equivalents to the claims.

What is claimed is:

1. A coupling structure comprising:
a retainer including a first holding member and a second holding member, the first holding member including a plurality of grooves in which a plurality of harnesses are disposed, and the second holding member being disposed to be opposed to the first holding member and closing the grooves;
a connector coupled to the harnesses; and
an outer cover provided around outer peripheries of the retainer and the connector.

2. The coupling structure of claim 1, wherein an inner surface of each of the grooves is a curved surface.

3. The coupling structure of claim 1, wherein
the grooves are formed in one surface portion or a plurality of surface portions of the first holding member, and
the second holding member or the second holding members are disposed to be opposed to the surface portion or the surface portions of the first holding member.

4. The coupling structure of claim 1, wherein
the connector includes a plurality of terminal holes in which the harnesses are inserted, respectively, and
the retainer is disposed to be opposed to an end surface of the connector, the terminal holes being formed in the end surface.

5. The coupling structure of claim 1, wherein the harnesses are engine harnesses.

6. A vehicle including the coupling structure of any one of claim 1.
